(19) United States
(12) Patent Application Publication
(10) Pub. No.: US 2016/0165322 A1
(43) Pub. Date: Jun. 9, 2016

(54) MATRIX CODE SCANNING SYSTEM

(71) Applicant: Michael Frederick Young, Swan Hills (CA)

(72) Inventor: Michael Frederick Young, Swan Hills (CA)

(21) Appl. No.: 14/562,199

(22) Filed: Dec. 5, 2014

(51) Int. Cl. H04N 21/858; H04N 21/4223; H04N 21/81; H04N 21/478; H04N 21/4782; H04N 21/41; H04N 21/4722

(52) U.S. Cl. CPC H04N 21/8586; H04N 21/4104; H04N 21/4126; H04N 21/4223; H04N 21/4722; H04N 21/47815; H04N 21/4782; H04N 21/812

(57) ABSTRACT

A system for facilitating access to a website is disclosed. The system comprises a television display that displays a unique matrix code and a scanner coupled with said television display. The scanner is configured for scanning, in response to user activation, the unique matrix code displayed in the television display, reading a website URL corresponding to the unique matrix code, generating a signal including a command for requesting the website URL, and transmitting the signal to a mobile computing device. They system also includes a mobile computing device configured for receiving said signal and transmitting a request for the website URL and displaying said website.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The present invention relates to the field of electronic commerce, and more specifically to the field of accessing websites for electronic commerce purposes.

### BACKGROUND

Watching television is a popular past time in today's society. Many advertisers advertise and promote their goods and services on television, as well as on the radio and using direct mail. Advertisers and promoters understand the importance of television marketing as it relates to sales of their goods services. Businesses derive substantial revenue from sales from advertising and marketing on television, and therefore considerable time and effort is placed by businesses when advertising on this medium.

Since the development of the Internet, advertisers and promoters have begun to promote and advertise their products and services, as well as the products and services of others, on the Internet. Technology has already been developed that allows consumers and users to scan a unique matrix code using a computing device that has scanning capabilities to retrieve networked information regarding a product or service or other information. Giving a consumer access to information on a good or service engages the consumer and potentially increases the likelihood that such consumer will purchase a good or service.

Advertisers and promoters have begun to display website addresses or website URLs on television commercials that provide information regarding a good or service in order to engage a consumer or potential purchaser. Many consumers visit the websites displayed on television commercials to purchase the good or service or to find more information about the good or service. However, advertisers and promoters may be losing a substantial amount of potential consumers and purchasers because it can be difficult for certain consumers and purchasers to type in a website URL into their computing device. For example, a consumer may have difficulty typing the URL into the computing device user interface because of physical disabilities such as arthritic hands, poor eyesight, poor dexterity in their hands, etc. Because of these physical limitations, a consumer desiring to learn more information about a good or service when a television commercial or informational segment appears on a television screen may be unable to immediately access such information. Additionally, it may be likely that because of a consumer or person's failure to immediately access such information, such consumer or person may forget to access such information in the future. Because of these issues, businesses may likely lose an opportunity to engage a consumer or complete a sales transaction.

As a result, there exists a need for improvements over the prior art and more particularly for a more efficient way of allowing advertisers to engage consumers via the television medium.

### SUMMARY

A system and method for facilitating access to a website is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a system for facilitating access to a website is disclosed. The system comprises a television display that displays a unique matrix code and a scanner coupled with said television display. The scanner is configured for scanning, in response to user activation, the unique matrix code displayed in the television display, reading a website URL corresponding to the unique matrix code, generating a signal including a command for requesting the website URL, and transmitting the signal to a mobile computing device. The system also includes a mobile computing device configured for receiving said signal and transmitting a request for the website URL and displaying said website.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a diagram of an operating environment that supports a system for facilitating access to a website, according to an example embodiment;

FIG. 2 is a block diagram illustrating the overall functions performed by the main components of the system for facilitating access to a website, according to an example embodiment; and,

FIG. 3 is a block diagram of a computing device, according to an example embodiment.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system for easily facilitating web access to a website by a user watching television. The disclosed embodiments improve over the prior art by providing a system that allows a consumer to access a website (which has been presented to him via a television) without having to type in a website's URL into the consumer's computing device. The disclosed embodiments also decrease the amount of time it takes to access a website via a URL. Additionally, the disclosed embodiments may increase the amount of consumers or users with which promoters and advertisers of goods and services have interactions.

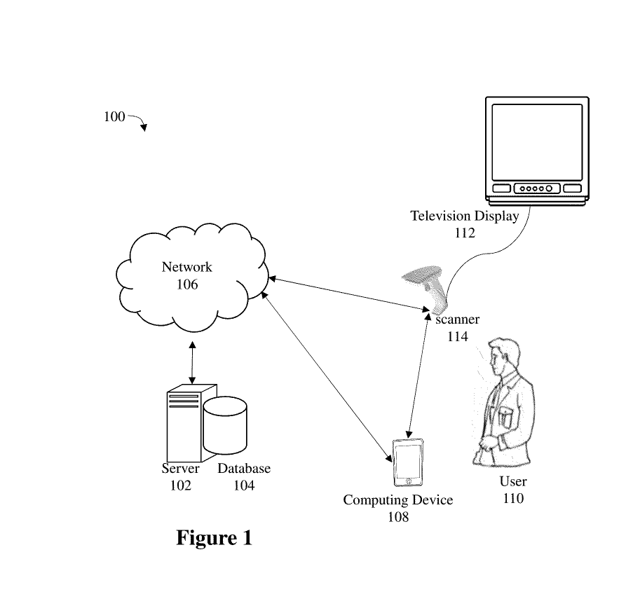

Referring now to the Figures, FIG. 1 is a diagram of an operating environment or system 100 that supports a system for facilitating access to a website over a communications network 106, according to an example embodiment. The environment 100 comprises a computing device 108 and scanner 114, which may communicate with server 102 via a communications network 106. Computing device 108, server 102 and scanner 114 may comprise any computing device, such as integrated circuits, printed circuit boards, processors, ASICs, PCBs, handheld computers, desktop computers, laptops, and game consoles, for example. Computing device 108 and scanner 114 may also comprise any mobile computing devices, such as cellular telephones, smart phones, tablet computers, and laptops, for example.

The scanner 114 may be a barcode reader or barcode scanner, which is an electronic device for reading printed barcodes. It may consist of a light source, a lens and a light sensor translating optical impulses into electrical ones. Additionally, it may contain decoder circuitry for analyzing the barcode's image data provided by the sensor and sending the barcode's content to the scanner's output port.

Computing device 108 and scanner 114 may be connected either wirelessly or in a wired or fiber optic form to the communications network 106. Communications network 106 may one or more packet switched networks, such as the Internet, or any local area networks, wide area networks, enterprise private networks, cellular networks, phone networks, mobile communications networks, or any combination of the above. In one embodiment, mobile computing device 108 and/or scanner 114 are a programmable logic controller or PLC.

Server 102 includes a software engine that delivers applications, data, program code and other information to networked devices 108, 114. The software engine of server 102 may perform other processes such as transferring multimedia data in a stream of packets that are interpreted and rendered by a software application as the packets arrive. FIG. 1 further shows that server 102 includes a database or repository 104, which may be a relational database comprising a Structured Query Language (SQL) database stored in a SQL server or a database that adheres to the noSQL paradigm. The mobile computing device and scanner may also each include databases. The database 104 may serve data, as well as related information, used by server 102 and mobile computing device 108 and scanner 114 during the course of operation of the invention. Various types of data may be stored in the database 104 of server 102. For example, the database 104 may store a plurality of data corresponding to a website, including a URL (Universal Resource Locator), IP address, audio and visual content, etc.

Mobile computing device 108, scanner 114 and servers 102 may each include program logic comprising computer source code, scripting language code or interpreted language code that perform various functions of the present invention. It should be noted that although FIG. 1 shows only one mobile computing device 108, one scanner 114, and one server 102, the system of the present invention supports any number of mobile computing devices, servers and client computing devices connected via network 106. Also note that although server 102 is shown as a single and independent entity, in one embodiment, server 102 and its functionality can be realized in a centralized fashion in one computer system or in a distributed fashion wherein different elements are spread across several interconnected computer systems.

The system 100 further includes a television display 112, which can be a computer display screen, television display screen, mobile computing device display screen, etc. The display screens can be plasma, LCD, LED, touch screen, etc. The television displays content distributed through a communications network, such as a cable TV network. In operation, the television display displays programming audio and visual content distributed through a network, such as a cable television or TV network. Businesses or persons developing audio and visual content can include in such audiovisual content a unique matrix code embedded in such content and displayed on the television display.

A unique matrix code is an optical machine-readable representation of data in one or more dimensions. A unique matrix code can be of the form UPC-A, UPC-E, ISBN, RSS-14, RSS-14E, RSS-14L, Interleaved 2 of 5, EAN/JAN-8, EAN/JAN-13, Code 39, Code 39 Full ASCII, Code 128, PDF417, QR Code, Data Matrix, and Optical Intelligence 2D. For example, a UPC code is a code that is typically used to mark merchandise in a supermarket, which can be read by optical scanners at checkout. Like UPC codes for supermarket merchandise, a unique matrix code may correspond with data related to the item being scanned. Each unique matrix code can have a website URL embedded in said unique matrix code such that when the code is scanned a website URL is read. Alternatively, each unique matrix code can have a unique identifier or number embedded in said unique matrix code such that when the unique identifier is scanned and sent to the server 102 via network 106, the server 102 looks up in the database 104 the website URL that corresponds to the unique identifier and returns the website URL to the device 108 or scanner 114.

The scanner is coupled with the television display 112. The scanner can be physically coupled to the television display using an audio/visual cable (“AV cable”), a co-axial cable, Ethernet cable, PS2 cable, or the line. Alternatively, the television display can be coupled to scanner using wirelessly technology such as a cellular network, satellite network, Bluetooth network and Wi-Fi network, etc.

The scanner also comprises an optical component configured for scanning the unique matrix code in response to activation by a user. A user can activate the optical components for scanning the matrix code by pressing a button, pulling a trigger, entering information, speaking, or writing, gesturing or interacting with a touch screen by drawing, dragging, pressing, tapping, with at least one object, etc. The optical component of the scanner can be a laser-based barcode scanner, an optical barcode scanner, a mobile device equipped with a digital camera, etc.

The scanner is also equipped and configured for generating a signal, wherein the signal includes a command for requesting the website URL corresponding with the unique matrix code displayed with the visual content on the television display 112. The signal may include a unique identifier garnered from the matrix code that was scanned. The scanner is also capable of transmitting such signal such that it can be detected by mobile computing devices 108.

The scanner is also capable of receiving a plurality of mobile computing device registration data corresponding with the mobile computing device. Such registration data may include a user name, password, network information, IP address, etc. such that the computing device and scanner may be in wireless communication with each other.

The mobile computing device is also capable and configured for receiving signals from the scanner, transmitting a request for a website URL corresponding with the code matrix displayed on the television display, and displaying websites on a display screen.

The system 100 may also include a network interface device communicatively coupled to a communications network. Such network interface device can also be configured for receiving a request for a website URL from mobile computing devices, transmitting requests for website URLs over the communications network and receiving data associated with website URLs over the communications network. Such network interface device may also facilitate the transferring of data between the mobile computing device 108 and the communication network.

As mentioned above, this communication may be completed through a packet switched network, such as the Internet, or any local area networks, wide area networks, enterprise private networks, cellular networks, phone networks, mobile communications networks, or any combination of the above. In one embodiment, the communications protocol used to send messages or data to and from mobile computing device 108, scanner 114, server 102 and the network interface device may include any of the communications protocols known in the art, such as HTTP, TCP, UDP, ICMP, FTP, MQTT and IMAP. In another embodiment, the communications protocol used to send messages or data to and from computers 150, 180, 102, 120 and 122 include any of the communications protocols that would fall under the Application Layer (7) of the OSI model.

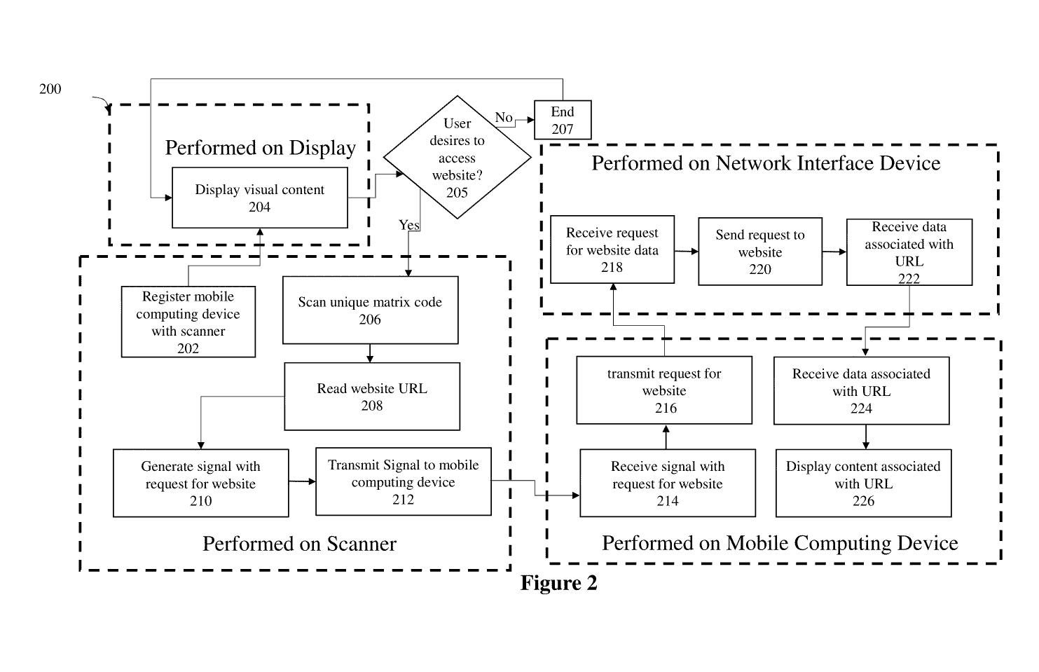

FIG. 2 is a block diagram showing the overall functions performed by the main components of the system for facilitating access to a website, according to an example embodiment. FIG. 2 illustrates that the system includes the television display 112, the scanner 114, mobile computing device 108 and, optionally, network interface device. The process begins with step 202, wherein a user registers the mobile computing device with the scanner. In this step the user can input a plurality of mobile computing device registration data, such as user name, password, as well as other data for identifying the user.

Next, the process moves to step 204 in which visual content is displayed on the television display or other display. Included in such display is a unique matrix code having a corresponding website URL encoded therein. As mentioned above the unique matrix code can have the form of UPC-A, UPC-E, ISBN, RSS-14, RSS-14E, RSS-14L, Interleaved 2 of 5, EAN/JAN-8, EAN/JAN-13, Code 39, Code 39 Full ASCII, Code 128, PDF417, QR Code, Data Matrix, or Optical Intelligence 2D.

Typically the website URL can be related to the content displayed on the television display. Next the process moves to step 205, wherein a user decides if the user desires to access the website related to the information displayed on the television display. If the user desires to access the website, then a user can, as shown in step 206, scan the unique matrix code. If the user does not desire to access the website, then the user does nothing and the process moves to step 207 and the process ends (and continuously reverts back to step 204).

In step 206, a user uses the scanner, which contains an optical component for scanning the unique matrix code displayed in the television display to scan the unique matrix code. As mentioned above, the optical component can comprise a laser-based barcode scanner, an optical barcode scanner, a mobile device equipped with a digital camera or any combination thereof. In order to activate the scanner, the scanner can be configured such that the optical component is activated upon the user pressing a button, pulling a trigger, entering information, speaking, or writing, gesturing or interacting with a touch screen by drawing, dragging, pressing, tapping, with at least one object or any combination thereof.

Next the process moves to step 208. In step 208, after the scanner has scanned the unique matrix code, the scanner reads the website URL encoded in the unique matrix code. In step 210, the scanner then generates a signal to be communicated to a registered mobile computing device. Such signal includes a command for requesting the website that was read by the scanner in step 208. In step 212, the scanner then transmits the signal having the request for the website that was read in step 208.

Next, in step 214, the mobile computing device receives the signal being emitted from the scanner having the request for the website. After receiving the signal, the mobile computing device, in step 216, transmits a request for a website. In step 218, the network interface device receives the request for website data from the mobile computing device. Next, in step 220, the network interface device sends a request for access to the website. Next, in step 222, the network interface device receives data associated with the website URL and transmits such data to the mobile computing device. In step 224, the mobile computing device receives the data associated with the URL. Next, in step 226, content associated with the website URL data is displayed on the mobile computing device.

The present system 100 and process 200 provides a user with having a website displayed on such user's mobile computing device without having to enter a website URL into the mobile computing device user interface. This makes it much easier for a person with physical limitations to access information related to content displayed on the television display 112.

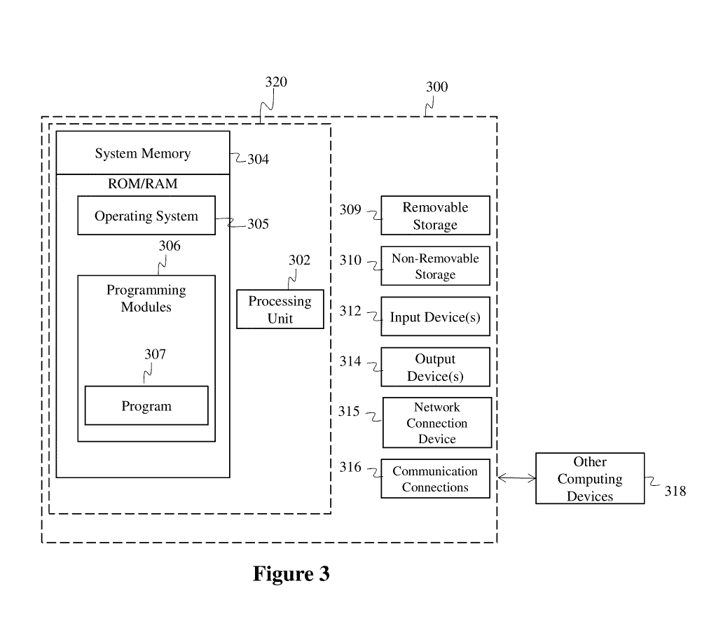

FIG. 3 is a block diagram of a system including an example computing device 300 and other computing devices. Consistent with the embodiments described herein, the aforementioned actions performed by mobile computing device 108, server 102, scanner 114 may be implemented in a computing device, such as the computing device 300 of FIG. 3. Any suitable combination of hardware, software, or firmware may be used to implement the computing device 300. The aforementioned system, device, and processors are examples and other systems, devices, and processors may comprise the aforementioned computing device. Furthermore, computing device 300 may comprise an operating environment for system 100 and processes 200, as described above. Process 200 may operate in other environments and are not limited to computing device 200.

With reference to FIG. 3, a system consistent with an embodiment of the invention may include a plurality of computing devices, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination or memory. System memory 304 may include operating system 305, and one or more programming modules 306. Operating system 305, for example, may be suitable for controlling computing device 300′s operation. In one embodiment, programming modules 306 may include, for example, a program module 307 for executing the actions of server 102 and computing device 108, for example. Furthermore, embodiments of the invention may be practiced in conjunction with a graphics library, other operating systems, or any other application program and is not limited to any particular application or system. This basic configuration is illustrated in FIG. 3 by those components within a dashed line 320.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a camera, a touch input device, etc. Output device(s) 314 such as a display, speakers, a printer, etc. may also be included. The aforementioned devices are only examples, and other devices may be added or substituted.

Computing device 300 may also contain a network connection device 315 (also known as a network interface device, network interface controller, network interface connection, etc.) that may allow device 300 to communicate with other computing devices 318, such as over a network in a distributed computing environment, for example, an intranet or the Internet. Device 315 may be a wired or wireless network interface controller, a network interface card, a network interface device, a network adapter or a LAN adapter. Device 315 allows for a communication connection 316 for communicating with other computing devices 318. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 304, including operating system 305. While executing on processing unit 302, programming modules 306 (e.g. program module 307) may perform processes including, for example, one or more of the stages of the process 200 as described above. The aforementioned processes are examples, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A system for facilitating access to a website, comprising:
a television display that displays a unique matrix code;
a scanner coupled with said television display, the scanner configured for:
scanning, in response to user activation, the unique matrix code displayed in the television display;
reading a website URL corresponding to the unique matrix code;
generating a signal including a command for requesting the website URL; and
transmitting the signal to a mobile computing device; and
a mobile computing device configured for receiving said signal, transmitting a request for the website URL and displaying said website.

2. The system of claim 1, the unique matrix code comprises the form of at least one of: UPC-A, UPC-E, ISBN, RSS-14, RSS-14E, RSS-14L, Interleaved 2 of 5, EAN/JAN-8, EAN/JAN-13, Code 39, Code 39 Full ASCII, Code 128, PDF417, QR Code, Data Matrix, and Optical Intelligence 2D.

3. The system of claim 1, wherein said scanner is further configured for receiving a plurality of mobile computing device registration data.

4. The system of claim 1, wherein the user activation comprises at least one of: pressing a button, pulling a trigger, entering information, speaking, or writing, gesturing or interacting with a touchscreen by drawing, dragging, pressing, tapping, with at least one object.

5. The system of claim 1, wherein the scanner comprises an optical component for scanning the unique matrix code displayed in the television display, wherein the optical component comprises at least one of: a laser-based barcode scanner, an optical barcode scanner, and a mobile device equipped with a digital camera.

6. The system of claim 1, wherein the scanner is coupled to the television display using a wireless technology.

7. The system of claim 1, wherein the scanner is coupled to the television display using an AV cable.

8. The system from claim 1, wherein said system is communicatively coupled to a network interface device communicatively coupled to a communications network, the network interface device configured for:
receiving a request for the website URL from the mobile computing device;
transmitting a request for the website URL over the communications network; and
receiving data for the website URL over the communications network.

9. A system for facilitating access to a website, the system communicatively coupled to a communications network, comprising:
a display unit that displays a unique matrix code;
a scanner coupled with said display unit, the scanner configured for:
scanning, in response to user activation, the unique matrix code displayed in the television display;
reading a website URL corresponding to the unique matrix code;
generating a signal including a command for requesting the website URL; and
transmitting the signal to a mobile computing device; and
a mobile computing device configured for receiving said signal, transmitting a request for the website URL and displaying said website; and
a network interface device communicatively coupled to the communications network, the network interface device configured for:
receiving a request for the website URL from the mobile computing device;
transmitting a request for the website URL over the communications network; and
receiving data for the website URL over the communications network.

10. The system of claim 9, the unique matrix code comprises the form of at least one of UPC-A, UPC-E, ISBN, RSS-14, RSS-14E, RSS-14L, Interleaved 2 of 5, EAN/JAN-8, EAN/JAN-13, Code 39, Code 39 Full ASCII, Code 128, PDF417, QR Code, Data Matrix, and Optical Intelligence 2D.

11. The system of claim 10, wherein said scanner is further configured for receiving a plurality of mobile computing device registration data.

12. The system of claim 11, wherein the user activation comprises at least one of: pressing a button, pulling a trigger, entering information, speaking, or writing, gesturing or interacting with a touchscreen by drawing, dragging, pressing, tapping, with at least one object.

13. The system of claim 12, wherein the scanner comprises an optical component for scanning the unique matrix code displayed in the television display, wherein the optical component comprises at least one of: a laser-based barcode scanner, an optical barcode scanner, and a mobile device equipped with a digital camera.

14. The system of claim 13, wherein the scanner is coupled to the display unit using a wireless technology, wherein the wireless technology comprises at least one of: a cellular network, satellite network, Bluetooth network and Wi-Fi network.

15. The system of claim 14, wherein the scanner is coupled to the television display using an AV cable.
